(19) United States
(12) Patent Application Publication
(10) Pub. No.: US 2007/0286380 A1
(43) Pub. Date: Dec. 13, 2007

(54) Method of providing services that can be used between network devices, and network device and storage medium suitable for implementing the method

(75) Inventors: Jin-woo Hong, Suwon-si (KR); Dae-gyu Bae, Suwon-si (KR); Se-hoon Moon, Seongnam-si (KR); Hyun-ah Sung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/636,571

(22) Filed: Dec. 11, 2006

(30) Foreign Application Priority Data
May 29, 2006 (KR) 10-2006-0048304

(51) Int. Cl. H04M 3/42

(52) U.S. Cl. 379/201.01

(57) ABSTRACT

A method of providing services between network devices is provided. The method includes transmitting a service announcement request from a network device; checking service compatibility between the network device that transmitted the service announcement request and a network device that has transmitted a service announcement response, when at least one service announcement response is received in response to the service announcement request; detecting a common service that can be commonly used between the network device and a network device which has service compatibility with the network device; and providing a user with information on available services that can be commonly used between the network devices based on the detected common service.

### CROSS-REFERENCE TO RELATED PATENT APPLICATION

This application claims priority from Korean Patent Application No. 10-2006-0048304, filed on May 29, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to providing services between network devices, and a network device and storage medium suitable for implementing the method.

2. Description of the Related Art

Network devices may include consumer electronic (CE) devices such as camcorders, compact disc (CD) players, digital versatile disc (DVD) players, audio players, digital televisions (DTV), and home theatre systems.

When a service that can be used between these network devices is provided, typically, the range of services that can be used by the entire framework is limited to one type of service. For example, if Moving Picture Experts Group 4 (MPEG4) is designated as a media format for the entire framework, the network devices belonging to that framework would exchange media data with one another based on only the MPEG4 format, but would not exchange media data based on media formats other than MPEG4.

Recently, the range of services that can be supported by network devices has expanded as various additional functions have been employed by the network devices. For example, a camcorder capable of outputting data in a Joint Photographic Experts Group (JPEG) format as well as an MPEG4 format and a digital television set capable of receiving data of various formats such as MPEG4, JPEG, and MPEG layer-3 (MP3) are known in the related art.

However, not all of the supportable services can be sufficiently utilized using a related art method of providing services between network devices, because the range of services of the entire framework is limited to one service type, as described above. In addition, even when a service type is commonly supported by all network devices, if that service type is not included in the service range of the entire framework, a user cannot be provided with that service.

For example, when MPEG4 is designated as a media format of the entire framework, the camcorder cannot utilize a data output function using the JPEG format, and the digital television set cannot utilize a data receiving function using the JPEG and MP3 formats. In other words, although the camcorder and the digital television set can commonly transmit and receive media data between each other using the JPEG format, they cannot utilize the JPEG format because the MPEG4 format has been already designated as a media format of the entire framework between network devices.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method of providing services between network devices based on the services supported by the network devices, a network device and a storage medium suitable for implementing the same.

The present invention also provides a method of providing services between network devices, in which a common service between the network devices can be provided, and a network device and a storage medium suitable for implementing the same.

According to an aspect of the present invention, there is provided a method of providing services that can be used between network devices, the method comprising: transmitting a service announcement request from a network device and checking service compatibility between the network device that transmitted the service announcement request and a network device that has transmitted a service announcement response, if at least one service announcement response is received in response to the service announcement request.

The method may further include: detecting a common service that is commonly used by both the network device and a network device having service compatibility with the network device; and providing a user with information on available services that are commonly used by the network devices, based on the detected common service. The method may further include transmitting a device script request to a network device having service compatibility with the network device; detecting a common service that is commonly used by both the network device and a network device having service compatibility with the network device, based on the received device script, when the device script is received and providing a user with information on available services that are commonly used by the network devices based on the detected common service.

According to another aspect of the present invention, there is provided a network device comprising: a transmit/receive module which transmits a service announcement request and receives at least one response to the service announcement request; a storage module which stores a script of the network device; a service compatibility check module which checks service compatibility between the network device and a network device that has transmitted a response.

The network device may further include: a common service detecting module which detects a common service that is commonly used by both the network device and a network device which has service compatibility with the network device; and a user interface module which provides a user with information on available services that are commonly used by the network devices, based on the common service.

According to another aspect of the present invention, there is provided a computer-readable medium having embodied thereon a computer program for performing a method of providing services between network devices, the method including: transmitting a service announcement request from a network device and checking service compatibility between the network device that transmitted the service announcement request and a network device that has transmitted a service announcement response, if at least one service announcement response is received in response to the service announcement request.

### BRIEF DESCRIPTION OF THE DRAWINGS

The above and other aspects of the present invention will become more apparent by describing in detail exemplary embodiments thereof with reference to the attached drawings in which:

FIG. 1 is an exemplary diagram illustrating a network to which a method of providing services between network devices according to an exemplary embodiment of the present invention is applied;

FIG. 2 is a functional block diagram illustrating a network device according to an exemplary embodiment of the present invention;

FIG. 3 is a detailed functional block diagram illustrating a service compatibility check module of FIG. 2;

FIG. 4 is an exemplary diagram illustrating a response script for responding to a service announcement request according to an exemplary embodiment of the present invention;

FIG. 5 is an exemplary diagram illustrating a device script included in a response to a service announcement request according to an exemplary embodiment of the present invention;

FIG. 6 is a block diagram illustrating a network device according to another exemplary embodiment of the present invention;

FIG. 7 is a flowchart illustrating a method of providing services between network devices according to an exemplary embodiment of the present invention;

FIG. 8 is a transaction diagram for describing sending and receiving of signals between network devices based on the flowchart of FIG. 7;

FIG. 9 is a flowchart illustrating a method of providing services between network devices according to another exemplary embodiment of the present invention;

FIG. 10 is a detailed operational flowchart illustrating a process of detecting a common service in the flowchart of FIG. 9;

FIG. 11 is a flowchart illustrating a method of providing services between network devices according to still another exemplary embodiment of the present invention; and

FIG. 12 is a transaction diagram for describing a method of processing signals between network devices based on the flowchart of FIG. 11.

### DETAILED DESCRIPTION OF THE EXEMPLARY EMBODIMENTS OF THE INVENTION

Exemplary embodiments of the present invention will now be described in detail with reference to the accompanying drawings.

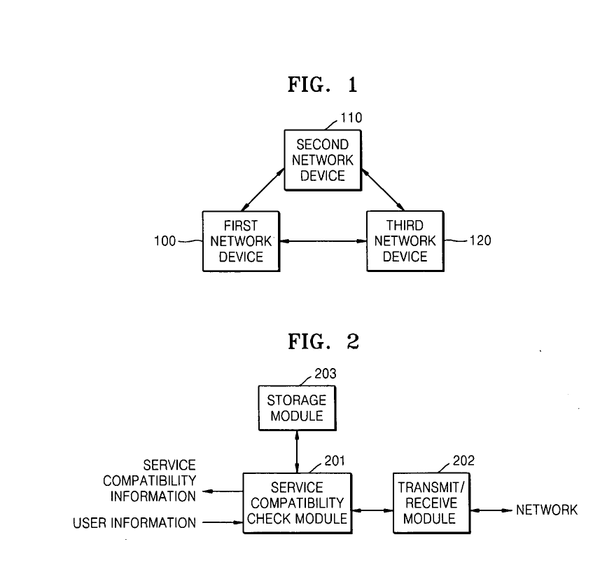

FIG. 1 is an exemplary diagram illustrating a network to which a method of providing services between network devices according to an exemplary embodiment of the present invention is applied. Referring to FIG. 1, the network includes first, second, and third network devices 100, 110, and 120. The network may include n network devices, where n denotes a natural number. The first to third network devices 100, 110, and 120 may be consumer electronic (CE) devices such as a camcorder and a digital television set. Since the network shown in FIG. 1 is a peer-to-peer network, the first to third network devices 100, 110, and 120 may perform device discovery, check service compatibility of the network devices, and detect a common service of the network devices based on peer-to-peer connections to provide a user with information on available services that can be used between network devices.

For this purpose, each of the first to third network devices 100, 110, and 120 may be constructed as shown in FIG. 2. FIG. 2 is a functional block diagram illustrating a network device 100 according to an exemplary embodiment of the present invention. The first network device 100 includes a service compatibility check module 201, a transmit/receive module 202, and a storage module 203.

If user information indicates that a service announcement request or device discovery is required, the service compatibility check module 201 causes the service announcement request to be output to the network through the transmit/receive module 202. The user information is information input by a user. If one or more responses to the service announcement request are received through the transmit/receive module 202, the service compatibility check module 201 checks the service compatibility between the first network device 100 and the responding network device. In FIG. 1, the responding network device may be at least one of the second and third network devices 110 and 120. If the service announcement request is transmitted from the second network device 110, the first and third network devices 100 and 120 will be the responding network devices.

The service compatibility check module 201 checks the service compatibility based on one of the script of the received response, a device script included in the received response, and a device script of the first network device 100 stored in the storage module 203.

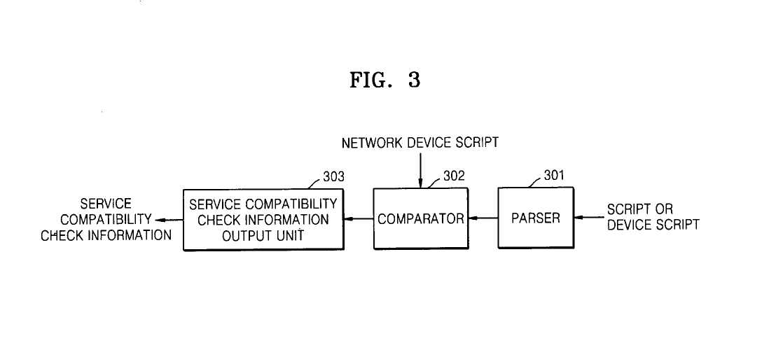

For this purpose, the service compatibility check module 201 may be constructed as shown in FIG. 3. FIG. 3 is a functional block diagram illustrating the service compatibility check module 201 in detail. Referring to FIG. 3, the service compatibility check module 201 includes a parser 301, a comparator 302, and a service compatibility check information output unit 303.

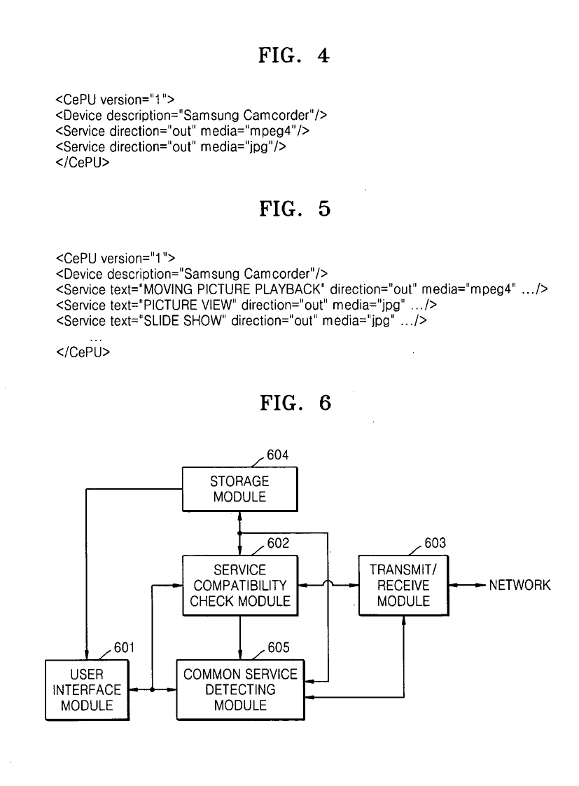

The parser 301 parses the script of the received response or the device script included in the received response. For example, when the service compatibility is checked based on the script of the received response, and the script of the received response is described as shown in FIG. 4, the parser 301 parses the script of the received response and obtains two media formats, MPEG4 and JPEG, and information on the data transmission directions, i.e., “out” (i.e., transmission), of the two media formats. FIG. 4 is an exemplary diagram illustrating a Consumer electronic Profile over Ultra-WideBand (CePU) script as an example of a script of the response to the service announcement request according to an exemplary embodiment of the present invention.

The parser 301 transmits the media format and information on the data transmission direction, that have been obtained, to the comparator 302. The comparator 302 compares the received media formats and information on the data transmission directions with those included in the device script of the first network device 100 read from the storage module 203, and outputs information representing whether or not there is an identical media format.

That is, assuming that the media formats and information on the data transmission directions obtained from the parser 301 are the same as those described above, if one of the media formats, MPEG4 and JPEG, is included in the device script read from the storage module 203, and the information on the data transmission directions is described as “in” (i.e., receipt), the comparator 302 outputs information representing that the responding network device and the first network device 100 use the same media format. In this case, the comparator 302 may output the identical media format and the information on its data transmission directions.

Assuming that the media format obtained from the parser 301 and information on its data transmission direction are the same as those described above, if the media formats, “MPEG4” and “JPEG”, are not provided in the device script read from the storage module 203, the comparator 302 outputs information representing that the responding network device and the first network device 100 do not use the same media format.

The service compatibility check information output unit 303 outputs information on the network device which has service compatibility with the first network device 100 as the service compatibility check information, based on the comparison result for each network device output from the comparator 302. For example, if the first network device 100 and the second network device 110 use the same media format, and the first network device 100 and the third network device 120 do not use the same media format, the service compatibility check information output unit 303 may output information on only the second network device 110 which has service compatibility with the first network device 100, or may separately output information on the second network device 110 which has service compatibility with the first network device 100 and information on the third network device 120 which does not have service compatibility with the first network device 100.

On the other hand, when the service compatibility is checked based on the device script included in the received response and the device script included in the received response is the same as that shown in FIG. 5, the parser 301 parses the device script included in the received response and obtains two media formats “MPEG4” and “JPEG” and information on their data transmission directions, each of which is designated as “out” (i.e., transmission). FIG. 5 illustrates an example of a device script included in a response to a service announcement request according to an exemplary embodiment of the present invention. The device script in FIG. 5 is a CE profile over Ultra-WideBand (CePU) script.

The operations of the comparator 302 and the service compatibility check information output unit 303 are the same as those described above.

As described above, the script of the received response or the device script included in the response and the script of the network device stored in the storage module 203 include a set of at least one media format and information on its data transmission direction, or a set of at least one media format, information on its data transmission direction, and information on a plurality of transmission protocols. A plurality of the transmission protocols are protocols that are supported by the network device and used to transmit data. When a transmission protocol is not previously defined between the network devices according to the media format, a transmission protocol may be included in the script of the response or the device script included in the response. The transmission protocol may include Transmission Control Protocol/Internet Protocol (TCP/IP). When checking the service compatibility between network devices, the exemplary embodiment of the present invention can be implemented so that the transmission protocol between network devices is first checked and then, if the transmission protocol between network devices is compatible, the service compatibility check described in FIG. 3 can be performed.

The service compatibility check module 201 may further include an information processing block (not shown in the drawing) that analyzes user information input by a user and processes the information to allow a service announcement request to be transmitted through the transmit/receive module 202. The service compatibility check module 201 may be included in a control module (not shown in the drawing) for controlling all functions of the first network device 100. The service compatibility check information output from the service compatibility check module 201 may be output through a display unit (not shown in the drawing). The user information may be input through a user information input unit (not shown in the drawing).

FIG. 6 is a functional block diagram illustrating a network device according to another exemplary embodiment of the present invention. Each of the first, second, and third network devices 100, 110, and 120 of FIG. 1 may be modified as shown in FIG. 6. Referring to FIG. 6, the first network device 100 includes a user interface module 601, a service compatibility check module 602, a transmit/receive module 603, a storage module 604, and a common service detecting module 605.

The user interface module 601 may allow a user to input information indicating that he/she wishes to request transmission of a service announcement request, and may also provide a user with available service information based on service compatibility check information and common service information. The available service information is information for service that can be used between network devices.

The service compatibility check module 602 operates similarly to the service compatibility check module 201 of FIG. 2. However, if it is determined that there is a network device which has service compatibility with the first network device 100, the service compatibility check module 602 enables operation of the common service detecting module 605. In this case, the service compatibility check module 602 may transmit a device script request to a network device which has service compatibility with the first network device 100 through the transmit/receive module 603.

When the common service detecting module 605 is enabled by the service compatibility check module 602, the common service detecting module 605 detects a common service between the network devices based on the script of the response transmitted from the transmit/receive module 603 or the device script included in the response and the device script of the first network device 100 transmitted from the storage module 604.

In other words, the common service detecting module 605 checks whether or not one media format included in the script of the response transmitted from the transmit/receive module 603 or the device script included in the response is included in the device script read from the storage module 604. As a result of the check, if the media format is included in the device script read from the storage module 604, the common service detecting module 605 checks whether or not the data transmission directions are matched. In other words, if the data transmission direction of the media format included in the script of the response or the device script included in the response is designated as “out” (i.e., transmission), the data transmission direction of the media format included in the device script read from the storage module 604 should be designated as “in” (receipt), in order to match their data transmission directions. The common service detecting module 605 checks whether or not the data transmission directions are matched based on the above condition.

If the data transmission directions are matched, the common service detecting module 605 detects the corresponding media format as a common service that can be used between the first network device 100 and the responding network device. The common service detecting module 605 establishes the detected common service as an available service that can be used between the first network device 100 and the responding network device. The established available service information may be output to the user interface module 201, may be stored in the storage module 604, or may be held in the common service detecting module 60 until a detecting operation for a common service between the first network device 100 and the responding network device is finished, and then output to the user interface module or stored in the storage module 604.

In addition, the common service detecting module 605 may separately detect a service detected as a common service and a service that is not detected as a common service to the user interface module 201, in order to allow the service detected as a common service and the service that is not detected as a common service to be separately output through the user interface module 201. In this case, the common service detecting module 605 may simultaneously output information on the network device which provides a service.

After performing a process of detecting a common service for one media format, the common service detecting module 605 checks whether or not there is another media format in the script of the received response or the device script included in the response. If there is another media format, the common service detecting module 605 repeatedly performs the aforementioned processes for the other media format, to detect a common service between the first network device 100 and the responding network device, and then updates the available service information based on the detected result.

For example, if the first network device is a camcorder capable of supporting MPEG4 and JPEG media formats, and the data transmission direction for each media format is designated as “out”, and if the responding network device is a digital television set capable of supporting the MPEG4 and JPEG media formats, and the data transmission direction for each media format is designated as “in”, the MPEG4 and JPEG media formats are detected as a common service between the first network device 100 and the responding network device, and the available service information is updated or established accordingly.

If a plurality of transmission protocols are included in the script of the response or the device script included in the response, the common service detecting module 605 detects a service as a common service that can be used between the network devices when the media formats and their data transmission directions are matched, and at least one of a plurality of transmission protocols is matched.

On the other hand, as shown in FIG. 5, when the common service is detected based on the device script included in the response, information on the media format and a corresponding service title (such as a moving picture playback, a picture view, or a slide show) may be provided as available service information. The service title may be provided based on a function (i.e., a picture-in-picture function) defined in a network device. For example, in the case of a digital television set having a picture-in-picture function, the service titles may include “main picture view”, “sub-picture view”, and the like. When the service titles are provided as described above, the user interface module 601 may provide available service information based on the service titles. Therefore, the media format and information on its data transmission direction can be defined by a function by a network device, the common service can be detected by a function by a network device, and the available service information can be provided by a function by a network device.

If the service compatibility check module 602 requests the network device which has the service compatibility to send the device script after checking the service compatibility, the common service detecting module 605 detects a common service based on the device script received in response to the device script request, regardless of the script of the received response or the device script included in the response.

In other words, when the first network device 100 checks service compatibility and does not transmit the device script request, the responding network device may transmit the script of the response or the device script included in the response as shown in FIG. 4. In this case, the common service detecting module 605 detects the common service as described above based on the script of the response or the device script included in the response. However, when the first network device 100 checks the service compatibility and then transmits the device script request to the network device which has service compatibility, the common service detecting module 605 detects the common service as described above based on the device script received in response to the device script request.

The transmit/receive module 603 transmits the response to the service announcement request to the common service detecting module 605, or transmits the device script received in response to the device script request to the common service detecting module 605.

The storage module 604 stores the device script of the first network device 100 and the available service information transmitted from the common service detecting module 605. The available service information stored in the storage module 604 may be output to the user interface module 601 in response to the request from the common service detecting module 605. The common service detecting module 605 may update the available service information stored in the storage module 604 whenever the common service information is detected. In addition, the common service detecting module 605 may update the available service information output to the user interface module 601 based on the detected common service information, whenever the common service is detected. The user interface module 601 may output the available service information output from the common service detecting module 605 or the storage module 604.

The network device functional block diagram of FIG. 6 may be implemented in such a way that the service compatibility check module 602 and the common service detecting module 605 are included in a control module (not shown in the drawing) for controlling the functions of the corresponding network device.

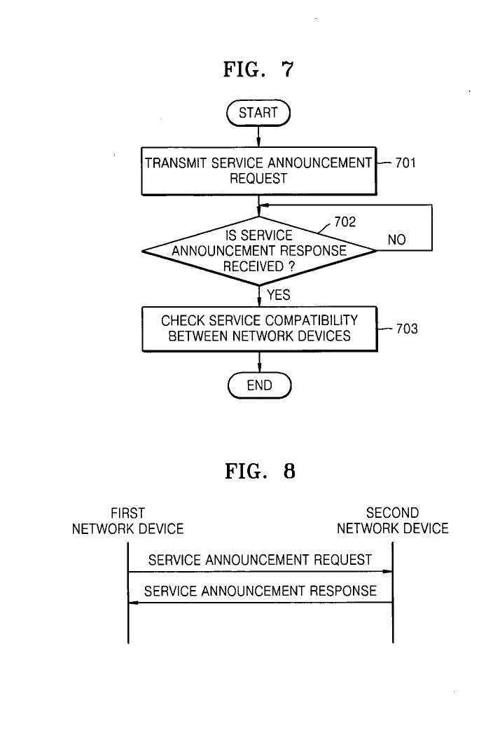

FIG. 7 is a flowchart illustrating a method of providing services that can be used between network devices according to an exemplary embodiment of the present invention. The flowchart of FIG. 7 will be described with reference to the first network device 100 of FIG. 1.

In operation 701, when a user of the first network device 100 makes a request to perform device discovery or transmits a service announcement request, the first network device 100 transmits a service announcement request to the network. Accordingly, the service announcement request is broadcasted to other network devices connected to the network, and other network devices that receive the service announcement request transmit the service announcement response to the first network device 100.

In operation 702, when at least one service announcement response is received in response to the service announcement request, the first network device 100 checks service compatibility with the network device that has transmitted the service announcement response. In FIG. 1, the second and third network devices 110 and 120 have transmitted the service announcement response. The service compatibility check is performed as described in association with FIGS. 2 and 3.

The service compatibility check between the network devices may be performed based on the script of the network device and the script of the received service announcement response, or based on the script of the network device and the device script included in the received service announcement response.

The script may include at least one media format supported by the network device and information on its data transmission direction. Otherwise, the script may include at least one media format supported by the network device, information on its data transmission direction, and information on a plurality of transmission protocols.

Accordingly, the network devices can perform device discovery between the network devices and check service compatibility based on a transaction of the service announcement request and response as shown in FIG. 8. FIG. 8 is a transaction diagram illustrating sending and receiving of signals between network devices based on the flowchart of FIG. 7.

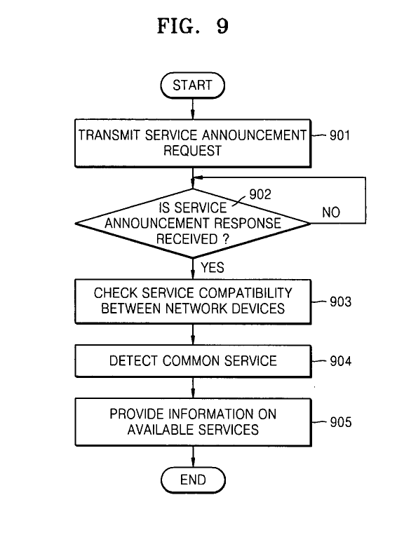

FIG. 9 is an operational flowchart illustrating a method of providing services that can be used between network devices according to another exemplary embodiment of the present invention. Similarly to FIG. 7, the operational flowchart of FIG. 9 will be described based on the first network device 100 of FIG. 1.

Operations 901 to 903 of FIG. 9 are performed in a similar way to operation 701 to 703 of FIG. 7. When it is identified in operation 903 that there is a network device which has service compatibility with the first network device 100, the first network device 100 detects a common service between the first network device 100 and the network device which has service compatibility with the first network device 100 in operation 904. For example, if the network device which has service compatibility with the first network device 100 is the second network device 110 of FIG. 1, the first network device 100 detects a common service between the first and second network devices 100 and 110.

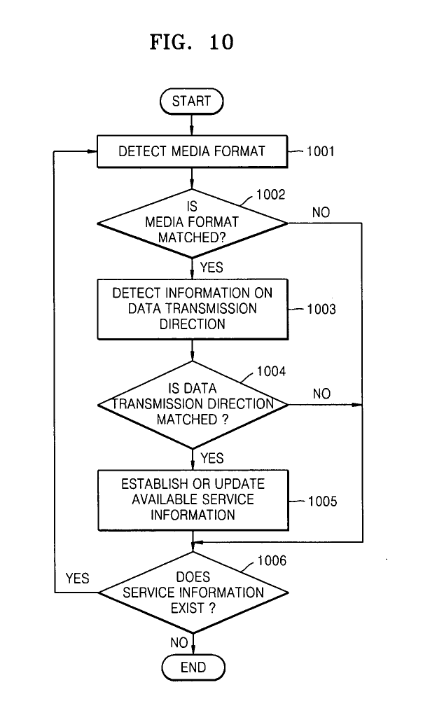

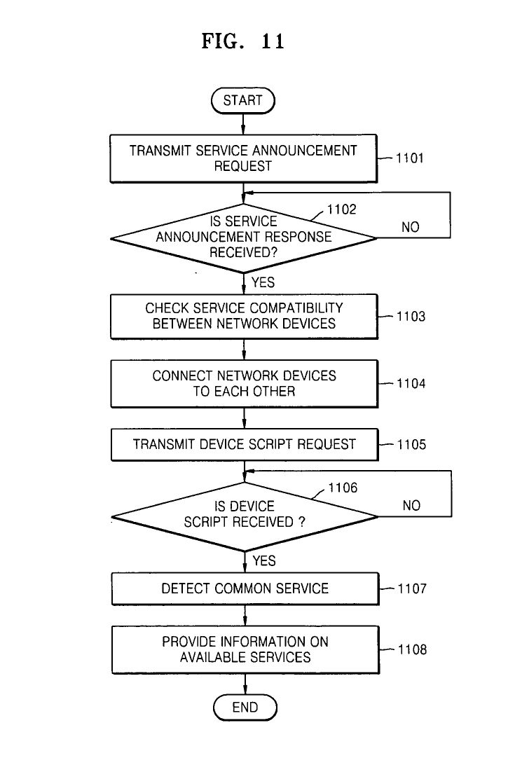

The common service between the first and second network devices 100 and 110 may be detected as shown in the operational flowchart of FIG. 10. FIG. 10 is a detailed flowchart illustrating the process of detecting a common service, i.e., operation 904, of FIG. 9.

In operation 1001, the first network device 100 detects media formats from the script of the received response, the device script included in the response, or the device script received in response to the device script request. Whether the media format to be detected is the script of the response, the device script included in the response, or the device script received in response to the device script request, can be determined based on the operational condition as described above in association with the common service detecting module 605 of FIG. 6.

In operation 1002, if there is a media format corresponding with the detected media format among the media formats included in the device script of the first network device 100, the first network device 100 detects information on data transmission directions of the detected media formats from the script of the received response, the device script included in the response, or the device script received in response to the device script request.

In operation 1004, if the information on the data transmission direction for the media format included in the device script of the first network device 100 is matched with information on the data transmission direction for the detected media format, the first network device 100 establishes or updates the information on available services that can be used by both the first and second network devices 100 and 110 in operation 1005.

If service information which does not perform the common service detecting process exists in the script of the received response, the device script included in the response, or the device script received in response to the device script request, the process of the first network device 100 is returned to operation 1001, and the aforementioned processes are repeated. However, if service information which does not perform the common service detecting process does not exist in the script of the received response, the device script included in the response, or the device script received in response to the device script request, the process of the first network device 100 terminates the common service detecting operation in operation 1006.

The first network device 100 may detect the common service as described above in association with FIG. 6 in addition to the above common service detecting operation.

Subsequently, in operation 905, the first network device 100 provides a user with information on available services that can be used by both the first network device 100 and the network device which has service compatibility with the first network device 100 based on the detected common service. The provided available service information may be the same as that described in FIG. 6.

FIG. 11 is an operational flowchart illustrating a method of providing services between network devices according to another exemplary embodiment of the present invention. The operational flowchart of FIG. 11 will be described based on the first network device 100 of FIG. 1 as shown in FIGS. 7 and 9.

Operations 1101 to 1103 of FIG. 11 are similarly performed to operations 701 to 703 of FIG. 3. If it is identified that there is a network device which has service compatibility with the first network device 100 in operation 1103, the first network device 100 establishes a connection between the first network device 100 and the network device which has service compatibility with the first network device 100 in operation 1104.

Then, in operation 1105, the first network device 100 transmits a device script request. Accordingly, when the device script is received from the network device connected to the first network device 100 in operation 1106, the first network device 100 detects a common service based on the received device script and the device script of the first network device 100 in operation 1107. The common service detecting process of operation 1107 and the available service providing process of operation 1108 are similarly performed to operation 904 and 905 of FIG. 9.

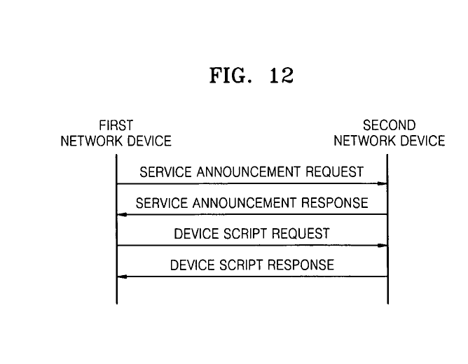

As a result, the network devices can perform device discovery and check service compatibility between network devices based on the service announcement request and response as shown FIG. 12 and can detect a common service based on the device script request and response. FIG. 12 is a transaction diagram illustrating the sending and receiving of signals between network devices based on the operational flowchart of FIG. 11. The device script is the same as that described in FIG. 6.

A program for executing a method of providing services between network devices according to an exemplary embodiment of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to an exemplary embodiment of the present invention, it is possible to enlarge a service range of an entire framework between network devices, by checking service compatibility between network devices based on the services supported by a network device, detecting a common service between the network devices which have service compatibility, and providing a user with the information on available services that can be used between network devices, based on the detected common service.

According to an exemplary embodiment of the present invention, it is possible to perform device discovery between network devices and check service compatibility based on a transaction of the service announcement request and response.

According to an exemplary embodiment of the present invention, the device discovery is performed and the service compatibility is checked by detecting a common service based on a peer-to-peer connection between network devices. Therefore, there is no need to provide an additional intermediate device between network devices in order to check service compatibility between network devices and detect a common service.

According to an exemplary embodiment of the present invention, it is possible to define a range of available services that can be used between network devices which have service compatibility, by providing information on the available services that can be used between network devices by a function by each network device function. While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope of the invention will be construed as being included in the present invention.

What is claimed is:

1. A method of providing services that can be used between network devices, the method comprising:
transmitting a service announcement request from a first network device; receiving at least one service announcement response from a second network device; and
checking service compatibility between the first network device that transmitted the service announcement request and the second network device that has transmitted the service announcement response.

2. The method of claim 1, wherein the checking of the service compatibility between the first and second network devices is performed based on a script of the first network device and a script of the received service announcement response.

3. The method of claim 2, wherein the script of the received service announcement response includes at least one media format supported by the second network device and information on a data transmission direction of the media format.

4. The method of claim 2, wherein the script of the received service announcement response includes at least one media format supported by the second network device, information on a data transmission direction of the at least one media format, and information on at least one transmission protocol.

5. The method of claim 1, wherein the checking of service compatibility between the first and second network devices is performed based on a script of the first network device and a device script included in the received service announcement response.

6. The method of claim 1, further comprising:
detecting a common service that is commonly used by both the first network device and the second network device which has service compatibility with the first network device; and providing information on available services that are commonly used by the first and second network devices, based on a detection of the common service.

7. The method of claim 6, wherein the common service is detected based on at least one media format included in a script of the service announcement response or a device script included in the service announcement response and information on a data transmission direction of the media format.

8. The method of claim 7, wherein information on the media format and the data transmission direction are defined by a function of the first or second network device, and available service information is provided by a function of the first or second network device.

9. The method of claim 1, further comprising:
transmitting a device script request to the second network device if the second network device has service compatibility with the first network device;
detecting a common service that is commonly used by both the first network device and the second network device based on the device script, if the device script is received; and
providing information on available services that are commonly used by the first and second network devices, based on a detection of the common service.

10. A first network device comprising:
a transmit/receive module which transmits a service announcement request and receives at least one response to the service announcement request;
a storage module which stores a script of the first network device;
a service compatibility check module which checks service compatibility between the first network device and a second network device that transmits a service announcement response.

11. The first network device of claim 10, wherein the service compatibility check module checks the service compatibility based on a script of the first network device stored in the storage module and a script of the service announcement response.

12. The first network device of claim 10, wherein the service compatibility check module checks the service compatibility based on a device script included in the service announcement response and a script of the first network device stored in the storage module.

13. The first network device of claim 11, wherein the script of the service announcement response or the script of the first network device includes at least one media format and information on data transmission direction.

14. The first network device of claim 11, wherein the script of the service announcement response or the script of the first network device includes at least one media format information on data transmission direction, and information on at least one transmission protocol.

15. The first network device of claim 10, further comprising:
a common service detecting module which detects a common service that is commonly used by both the first network device and the second network device which has service compatibility with the first network device; and
a user interface module which provides information on available services that are commonly used by the first and second network devices, based on the common service.

16. The first network device of claim 15, wherein the common service detecting module detects the common service by a function by the first and second network devices, and
wherein the available service information is provided by a function by the first and second network devices.

17. The first network device of claim 15, wherein the common service detecting module detects the common service based on a script included in the service announcement response and a script of the first network device stored in the storage module.

18. The network device of claim 15, wherein the common service detecting module detects the common service based on a device script of the second network device which has service compatibility with the first network device and a device script stored in the storage module of the first network device.

19. A computer-readable medium having embodied thereon a computer program for performing a method of providing services between network devices, the method comprising:
transmitting a service announcement request from a first network device; and
receiving at least one service announcement response from a second network device; and
checking service compatibility between the first network device that transmitted the service announcement request and the second network device that transmits a service announcement response.

20. The computer-readable medium of claim 19, wherein the method further comprises:
detecting a common service that is commonly used by both the first network device and the second network device which has service compatibility with the first network device; and
providing information on available services that are commonly used by the network devices, based on a detection of the common service.
